(19) United States
(12) Patent Application Publication
(10) Pub. No.: US 2017/0104244 A1
(43) Pub. Date: Apr. 13, 2017

(54) POSITIVE ELECTRODE COMPOSITION FOR OVERDISCHARGE PROTECTION

(71) Applicant: General Electric Company, Schenectady, NY (US)

(72) Inventors: Roger Neil Bull, Derby (GB); Roy C. Galloway, Derby (GB); Connor Douglas Anthony Brady, Birmingham (GB); Peter Barrow, Clifton (GB)

(21) Appl. No.: 14/876,892

(22) Filed: Oct. 7, 2015

(51) Int. Cl. H01M 10/42; H01M 4/38; H01M 10/39; H01M 4/58

(52) U.S. Cl. CPC H01M 10/4235; H01M 4/582; H01M 4/38; H01M 10/399; H01M 2004/028

(57) ABSTRACT

A positive electrode composition for an electrochemical cell is provided. One example includes at least one electroactive metal selected from the group consisting of nickel, titanium, vanadium, niobium, molybdenum, cobalt, chromium, silver, antimony, cadmium, tin, lead, and zinc. The positive electrode composition can further include at least one alkali metal halide and an electrolyte salt comprising a reaction product of a second alkali metal halide and a metal halide. The electrolyte salt can have a melting point of less than about 300 degrees Celsius. The positive electrode composition can further include manganese present in an amount sufficient to create an overdischarge plateau for the electrochemical cell

### FIELD OF THE INVENTION

The present subject matter relates generally to electrochemical cells used in energy storage devices, and more particularly to an electrode for an energy storage device.

### BACKGROUND OF THE INVENTION

Metal halide electrochemical cells, such as sodium-metal chloride batteries, can include a molten metal negative electrode (usually referred to as the anode) and a beta-alumina solid electrolyte. Metal halide electrochemical cells can be of considerable interest for energy storage applications. A metal halide electrochemical cell can include an anode (e.g. molten sodium). In addition to the anode, the cell can include a positive electrode (usually referred to as a cathode) that supplies/receives electrons during charging and discharging of the cell. The cathode composition can include a mixture of electroactive metal and alkali metal halide, which may be combined in the form of granules. The cathode composition may be infused with a molten electrolyte.

Failure of metal halide electrochemical cells by overdischarge can be a reliability concern during operation of energy storage devices. In sodium metal halide cells, overdischarge in the cell can occur during discharge at low states of charge when the sodium reservoir in the anode compartment is depleted. Early in life, when cell performance is well balanced, an end of discharge voltage limit can be reliably applied to prevent cells from failing. However, with continuous long-term cycling, the uniformity of cell performance may decrease and individual cells within an energy storage device or system may display reduced capacity relative to other energy cells. In this case, a voltage limit during discharge may not adequately protect cells with reduced capacity from failing due to overdischarge.

### BRIEF DESCRIPTION OF THE INVENTION

Aspects and advantages of embodiments of the present disclosure will be set forth in part in the following description, or may be learned from the description, or may be learned through practice of the embodiments.

One example aspect of the present disclosure is directed to a cathode composition for an electrochemical cell. The cathode composition includes at least one electroactive metal selected from the group consisting of nickel, titanium, vanadium, niobium, molybdenum, cobalt, chromium, silver, antimony, cadmium, tin, lead, and zinc. The cathode composition further includes at least one alkali metal halide and an electrolyte salt comprising a reaction product of a second alkali metal halide and a metal halide. The electrolyte salt has a melting point of less than about 300 degrees Celsius. The cathode composition further includes manganese present in an amount sufficient to create an overdischarge plateau for the electrochemical cell.

Another example aspect of the present disclosure is directed to an energy storage device having a positive electrode composition disposed in a positive electrode compartment. The positive electrode composition includes at least one electroactive metal selected from the group consisting of nickel, titanium, vanadium, niobium, molybdenum, cobalt, chromium, silver, antimony, cadmium, tin, lead, and zinc. The positive electrode composition further includes at least one alkali metal halide and an electrolyte salt comprising a reaction product of a second alkali metal halide and a metal halide. The electrolyte salt has a melting point of less than about 300 degrees Celsius. The positive electrode composition further includes manganese present in an amount sufficient to create an overdischarge plateau for the electrochemical cell.

Yet another example aspect of the present disclosure is directed to a method of controlling an energy storage device. The energy storage device has a positive electrode composition including at least one electroactive metal selected from the group consisting of nickel, titanium, vanadium, niobium, molybdenum, cobalt, chromium, silver, antimony, cadmium, tin, lead, and zinc. The positive electrode composition includes at least one alkali metal halide; an electrolyte salt comprising a reaction product of a second alkali metal halide and a metal halide. The electrolyte salt has a melting point of less than about 300 degrees Celsius. The positive electrode composition includes manganese present in amount ranging from about 0.3% by weight of a granule portion of the positive electrode composition to about 2% by weight of a granule portion of the positive electrode composition. The positive electrode composition includes iron present in an amount ranging from about 5% by weight of a granule portion of the positive electrode composition to about 10% by weight of a granule portion of the positive electrode composition. The method includes identifying a first potential associated with a first overdischarge plateau attributable at least in part to the manganese; identifying a second potential associated with a normal discharge attributable at least in part to the iron; and setting an overdischarge protection limit for a control system for controlling the energy storage device based at least in part on the first potential and the second potential.

Variations and modifications can be made to these example aspects of the present disclosure.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a front cross-sectional view of an example energy storage device according to example embodiments of the present disclosure;

FIG. 2 depicts a graphical representation of discharge of an example energy storage device having a positive electrode composition according to example embodiments of the present disclosure; and

FIG. 3 depicts a flow diagram of an example method according to example embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to a positive electrode composition for an energy storage device, such as a sodium metal halide electrochemical cell. More particularly, the positive electrode composition includes an addition of manganese or manganese chloride to introduce an overdischarge plateau to the electrochemical cell. Without being bound by any particular theory, it has been discovered that the addition of manganese to the positive electrode composition of the electrochemical cell can create a reaction (e.g., a Mn/MnCl₂ couple) that occurs at a lower potential relative to other overdischarge plateaus resulting from, for instance, iron in the positive electrode composition (e.g. a Fe/FeCl₂ couple).

The additional overdischarge plateau provided by the addition of manganese to the positive electrode composition can act as an overdischarge safety net. For instance, in one embodiment, an end of discharge protection value can be set between a first overdischarge plateau resulting from, for instance, the Fe/FeCl₂ couple and a second overdischarge plateau resulting from the Mn/MnCl₂ couple. In this way, potentially weak cells in an energy storage system will encounter the overdischarge plateau associated with the addition of manganese to the positive electrode cell rather than failing from overdischarging.

In example embodiments, the positive electrode composition includes at least one electroactive metal selected from the group consisting of nickel, titanium, vanadium, niobium, molybdenum, cobalt, chromium, silver, antimony, cadmium, tin, lead, and zinc. For instance, the electroactive metal can be present in an amount in a range from about 48% percent by weight of a granule portion of the positive electrode composition to about 68% percent by weight of the granule portion of the positive electrode composition. As used herein, the use of the term “about” in conjunction with a numerical value refers to within 30% of the numerical value. As used herein, amounts expressed as a percentage by weight of a positive electrode composition are calculated based on a percentage by weight of a granule portion of the portion of the positive electrode composition without infusion of the molten electrolyte.

The positive electrode composition can further include at least one first alkali metal halide and an electrolyte salt comprising a reaction product of a second alkali metal halide and a metal halide (e.g., aluminum halide). The electrolyte salt can have a melting point of less than about 300 degrees Celsius.

The cathode composition can further include manganese (e.g., manganese ions, manganese chloride, etc.) in an amount sufficient to create an overdischarge plateau for an electrochemical cell. For instance, the cathode composition can include manganese present in an amount ranging from about 0.3% by weight of the cathode composition to about 2% by weight of a granule portion of the cathode composition, such as about 0.4% to 1.5% by weight of a granule portion of the cathode composition, such as about 1.4% by weight of a granule portion of the cathode composition.

In particular embodiments, the cathode composition can include iron present in an amount to create an additional overdischarge plateau for the electrochemical cell. The additional overdischarge plateau can be associated with a greater potential relative to the overdischarge plateau associated with the manganese. In embodiments, the cathode composition can include iron present in an amount ranging from about 5% by weight of a granule portion of the positive electrode composition to about 10% by weight of a granule portion of the positive electrode composition. The positive electrode composition may also include products of the chemical or electrochemical interaction of the various elements of any of the embodiments described herein.

It is believed that the particular features set forth above for the positive electrode composition can enhance the performance of an energy storage device in which the positive electrode is incorporated, (e.g., a device based on high-temperature metal-halide/sodium cells), by increasing the maximum discharge power density of the cells. This may also increase the amount of time that these cells can sustain high-power discharging.

As used herein, a cathodic material is a material that supplies electrons during the charging process of a battery, and is present as part of a redox reaction. In contrast, an anodic material accepts electrons during the charging process of a battery, and is also present as part of the redox reaction. The positive electrode includes cathodic materials having differing functions: an electrode material, a support structure, and a current collector. The electrode materials are present in the positive electrode as participating electrochemical reactants, both in their oxidized or reduced state, or at some state between full oxidation or reduction. The electroactive metal is a usually a metal that oxidizes in molten sodium tetrachloroaluminate to the metal salt, above the oxidation potential of aluminum (about 1.58 V vs. Na), and below the oxidation potential of chloride (about 4.15 V vs. Na).

The support structure of the positive electrode usually does not undergo any significant change during any chemical reaction in the charge/discharge states. However, the support structure does provide electron transport, and supports the electrode material as it undergoes chemical reaction, and allows for a surface upon which solids may precipitate as needed. (An electrolyte is a medium that provides an ion transport mechanism between the positive and negative electrodes of a cell, and may act as a solvent for the oxidized form of the electrode material). Additives that facilitate the ion transport mechanism, but do not themselves provide the mechanism, are distinguished from the electrolyte itself

The electroactive metal of the positive electrode composition can be at least one transition metal selected from the group consisting of titanium, vanadium, niobium, molybdenum, nickel, cobalt, chromium, manganese, molybdenum, and silver. In other embodiments, the electroactive metal can be at least one metal selected from antimony, cadmium, tin, lead, and zinc. In one specific embodiment, the electroactive metal is antimony.

In one embodiment, the electroactive metal (or several of the metals) can be employed in the form of a salt. For example, nitrates, sulfides, or halides of the electroactive metal can be used. In one embodiment, halide salts (one or more of them) are preferred.

In some instances, the amount of electroactive metal present in the positive electrode composition is in a range from about 48% percent by weight of a granule portion of the positive electrode composition to about 68% percent by weight of the granule portion of the positive electrode composition. One skilled in the art will appreciate that the electroactive metal, for example, nickel, functions as the positive electrode grid. If the amount of nickel is not high enough to percolate electric current, the cell may not function as expected. On the other hand, an amount of nickel that is in excess of what is needed to percolate the current may occur at the expense of the desirable levels of the electrolyte salt and/or the alkali metal halide, both of which perform critical functions.

The positive electrode composition can include iron. In one embodiment, the amount of iron present in the positive electrode composition is in a range from about 5% by weight of a granule portion of the positive electrode composition to about 10% by weight of a granule portion of the positive electrode composition.

The positive electrode composition also includes a first alkali metal halide. In one embodiment, the first alkali metal halide is at least one alkali metal halide selected from sodium chloride, sodium iodide, sodium bromide, sodium fluoride, potassium chloride, potassium iodide, potassium bromide, potassium fluoride, lithium chloride, lithium iodide, lithium bromide, lithium fluoride, and cesium chloride. In some specific embodiments, the first alkali metal halide is selected from the group consisting of sodium chloride, sodium iodide, and lithium chloride. In one embodiment, the amount of the first alkali metal halide present in the positive electrode composition is in a range from about 30% by weight of a granule portion of the positive electrode composition to about 45% by weight of a granule portion of the positive electrode composition.

The electrolyte salt of the positive electrode composition comprises the reaction product of a second alkali metal halide and a metal halide, such as aluminum halide. In some specific embodiments, the aluminum halide is aluminum chloride. The electrolyte salt should have a melting point of less than about 300 degrees Celsius. In one embodiment, the electrolyte salt has a melting point in a range from about 300 degrees to about 250 degrees Celsius, from about 250 degrees Celsius to about 200 degrees Celsius, or from about 200 degrees Celsius to about 150 degrees Celsius. In one embodiment, the melting point of the electrolyte salt is about 185 degrees Celsius.

In one embodiment, the second alkali metal halide is at least one alkali metal halide selected from sodium chloride, sodium iodide, sodium bromide, sodium fluoride, potassium chloride, potassium iodide, potassium bromide, potassium fluoride, lithium chloride, lithium iodide, lithium bromide, lithium fluoride, and cesium chloride. In one embodiment, the second alkali metal halide is sodium chloride. In one embodiment, the amount of electrolyte salt employed is in a range of about 47% by weight of a granule portion of the positive electrode composition to about 52% by weight of the granule portion of the positive electrode composition.

In one embodiment, the second alkali metal halide and the metal halide of the electrolyte salt, are present in a molar ratio in a range from about 1:1 to about 1:2 in the reaction product. In another embodiment, the second alkali metal halide and the metal halide are present in a molar ratio in a range from about 0.53:0.48 to about 0.45:0.55 in the reaction product. In one embodiment, the electrolyte salt is sodium tetrachloroaluminate, which is a reaction product of sodium chloride and aluminum chloride.

In one embodiment, the positive electrode composition may further include aluminum, (e.g., in a form other than an electrolyte salt or an aluminum halide). The aluminum can be in elemental form, (e.g., aluminum metal flakes or particles). The aluminum may assist in improving the porosity of the granules formed using the electroactive metal, iron, and the alkali metal halide. In one embodiment, the amount of aluminum present in the positive electrode composition is in a range from about 0.5% to 1.2% by weight of a granule portion of the positive electrode composition.

In one embodiment, the positive electrode composition can further include sulfur, in the form of molecular sulfur or a sulfur-containing compound. If present, the level of sulfur is usually in the range from about 0.1 weight percent to about 3 weight percent, based on the total weight of the positive electrode composition.

In some other embodiments, the positive electrode composition is substantially free of sulfur, (e.g., containing, at most, impurity levels). The absence of sulfur is desirable in some cases, because sulfur may be corrosive to diffusion bonds between ceramics and metals, which are often used in the electrochemical cells. Also sulfides have been demonstrated to sometimes reduce performance in some applications.

In one embodiment, the positive electrode composition may include other additives that may beneficially affect the performance of an energy storage device. Such performance additives may increase ionic conductivity, increase or decrease solubility of the charged cathodic species, improve wetting of a solid electrolyte, i.e., the separator, by a molten electrolyte, or prevent “ripening” of the positive electrode microdomains, to name several utilities. In one embodiment, the performance additive may be present in an amount that is less than about 5 mole percent, based on the total, combined moles of the first alkali metal halide, the electrolyte salt, and the electroactive metal present in the positive electrode composition. In one embodiment, the performance additive may be an alkali metal halide salt. In some cases, the performance additive may comprise a bromide salt, a fluoride salt, or an iodide salt of an alkali metal halide. Suitable examples of performance additives include sodium iodide and sodium fluoride.

In accordance with one aspect of the present disclosure, an article is provided. The article includes a positive electrode composition, as described herein. As one non-limiting example, the article can be an energy storage device. The device usually includes (a) a first compartment comprising an alkali metal; (b) a second compartment including a positive electrode composition (as set forth above); and (c) a solid separator capable of transporting alkali metal ions between the first and the second compartments.

The device usually includes a housing having an interior surface defining a volume. A separator is disposed in the volume. The separator has a first surface that defines at least a portion of a first compartment, and a second surface that defines a second compartment. The first compartment is in ionic communication with the second compartment through the separator. As used herein, the phrase “ionic communication” refers to the traversal of ions between the first compartment and the second compartment, through the separator.

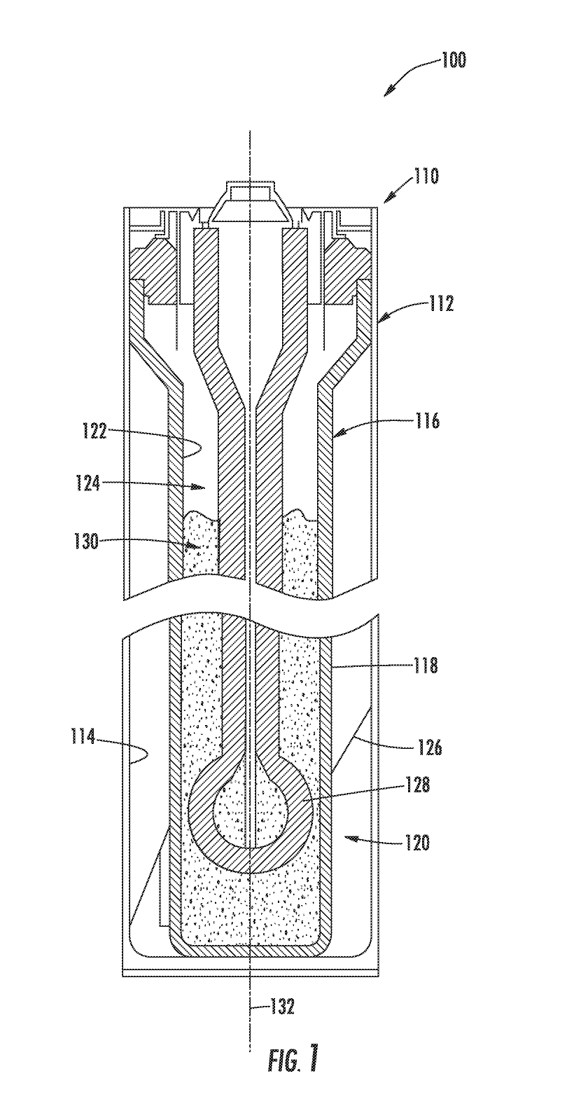

Referring to FIG. 1 an electrochemical cell 100 is provided. More particularly a front cross-sectional view 110 of the electrochemical cell 100 is provided. The electrochemical cell 100 includes a housing 112. The housing 112 has an interior surface 114 defining a volume. A separator 116 is disposed inside the housing 112. The separator 116 has a first surface 118 that defines a first compartment 120, e.g., an anode compartment. The separator has a second surface 122 that defines a positive electrode compartment 124. An anode current collector 126 is connected to the anode compartment 120. A positive electrode current collector 128 is connected to the positive electrode compartment 124. A positive electrode composition 130 is disposed inside the positive electrode compartment 124. The positive electrode composition 130 includes at least one electroactive metal, manganese, an alkali metal halide, an electrolyte salt.

The housing can be sized and shaped to have a cross-sectional profile that is square, polygonal, circular, or cloverleaf, to provide maximal surface area for alkali metal ion transport; and can have a width-to-length ratio that is greater than about 1:10, along a vertical axis 132. In one embodiment, the length-to-width ratio of the housing is in a range of from about 1:10 to about 1:5, from about 1:5 to about 1:1, from about 1:1 to about 5:1, from about 5:1 to about 10:1, or from about 10:1 to about 15:1. The housing can be formed from a material that is a metal, ceramic, or a composite. The metal can be selected from nickel or steel, and the ceramic is typically a metal oxide.

The ionic material transported across the separator between the anode compartment and the positive electrode compartment can be an alkali metal. Suitable ionic materials may include one or more of sodium, lithium and potassium.

Typically, the anode compartment is empty in the ground state (uncharged state) of the electrochemical cell, and is then filled with metal from reduced metal ions that move from the positive electrode compartment to the anode compartment through the separator, during operation of the cell. The anodic material, for example, sodium, is molten during use. The first compartment or the anode compartment may receive and store a reservoir of anodic material.

Additives suitable for use in the anodic material may include a metal oxygen scavenger. Suitable metal oxygen scavengers may include one or more of manganese, vanadium, zirconium, aluminum, or titanium. Other useful additives may include materials that increase wetting of the separator surface 116, defining the anode compartment, by the molten anodic material. Additionally, some additives may enhance the contact or wetting between the separator and the current collector, to ensure substantially uniform current flow throughout the separator.

The separator is usually an alkali metal ion conductor solid electrolyte that conducts alkali metal ions during use between the first compartment and the second compartment. Suitable materials for the separators may include an alkali-metal-beta′-alumina, alkali-metal-beta″-alumina, alkali-metal-beta′-gallate, or alkali-metal-beta′-gallate. In various embodiments, the solid separator may include a beta-alumina, a beta″-alumina, a gamma alumina, a micromolecular sieve, for example, a tectosilicate, such as a felspar, or a felspethoid; or a zeolite, e.g., a synthetic zeolite such as zeolite 3A, 4A, 13X, or ZSM-5. Other exemplary separator materials are rare-earth silicophosphates; silicon nitride; or other types of silicophosphates (e.g., NASICON: Na₃Zr₂Si₂PO₁₂). In one embodiment, the separator comprises a beta alumina material. In another embodiment, a portion of the separator is alpha alumina; and another portion of the separator is beta alumina. The alpha alumina may be relatively more amenable to bonding (e.g., compression bonding) than beta alumina, and may help with sealing and/or fabrication of the energy storage device.

The separator of the electrochemical cell may be stabilized by the addition of small amounts of a dopant. The dopant may include one or more oxides selected from lithia, magnesia, zinc oxide, and yttria. These stabilizers may be used alone, or in combination with themselves (i.e., other stabilizers), or with other materials. In one embodiment, the separator comprises a beta alumina separator electrolyte (BASE), and may include one or more dopants.

As noted above, the separator is disposed within the volume of the housing 112. The separator may have a cross-sectional profile normal to a vertical axis 132 of the housing 112, for example, a circle, a triangle, a square, a cross, or a star. Alternatively, the cross-sectional profile of the separator can be planar about the vertical axis 132. A planar configuration (or one with a slight dome) may be useful in a prismatic or button-type battery configuration, where the separator is domed or dimpled. Similarly, the separator can be flat or undulated. In one embodiment, the solid separator may include a shape that may be flat, undulated, domed or dimpled, or that comprises a shape with a cross-sectional profile that may be an ellipse, triangle, cross, star, circle, cloverleaf, rectangular, square, or multi-lobal.

The separator can be a tubular container in one embodiment, having at least one wall. The thickness of the wall will influence the ionic conductivity and the resistance across the wall. In some embodiments, the thickness of the wall is less than about 5 millimeters. A cation facilitator material can be disposed on at least one surface of the separator, in one embodiment. The cation facilitator material may include, for example, selenium.

Optionally, one or more shim structures can be disposed within the volume of the housing. The shim structures support the separator within the housing. The shim structures can protect the separator from vibrations caused by motion of the cell during use, and thus reduce or eliminate movement of the separator, relative to the housing. In one embodiment, a shim structure can function as a current collector.

The energy storage device may include a plurality of current collectors, including anode current collectors and positive electrode current collectors. The anode current collector is in electrical communication with the anode chamber, and the positive electrode current collector is in electrical communication with the contents of the positive electrode chamber. Suitable materials for the anode current collector may include steel, tungsten, titanium, nickel, copper, molybdenum, and combinations of two or more of the foregoing metals. Other suitable materials for the anode current collector may include carbon. The positive electrode current collector may be a wire, paddle or mesh formed from nickel, molybdenum, tungsten, platinum, palladium, gold, nickel, copper, carbon, or titanium. The current collector may be plated or clad. In one embodiment, the current collector is free of iron. The plurality of current collectors can have thickness greater than about 1 millimeter (mm).

The second compartment of the energy storage device includes the positive electrode composition according to example aspects of the present disclosure. As noted above, the positive electrode composition comprises: at least one electroactive metal; manganese; and an alkali metal halide. The electroactive metal may be at least one selected from the group consisting of titanium, vanadium, niobium, molybdenum, nickel, cobalt, chromium, manganese, silver, antimony, cadmium, tin, lead, and zinc.

In one specific embodiment, the alkali metal forming the first alkali metal halide may be sodium, and the separator may be beta-alumina. In another embodiment, the alkali metal forming the first alkali metal halide may be potassium or lithium, with the separator then being selected to be compatible therewith.

A plurality of the electrochemical cells can be organized into an energy storage system. Multiple cells can be connected in series or parallel, or in a combination of series and parallel. For convenience, a group of coupled cells may be referred to as a module or pack. The ratings for the power and energy of the module may depend on such factors as the number of cells in the module. Other factors may be based on specific criteria for end-use applications.

In one embodiment, the energy storage device may be rechargeable over a plurality of charge-discharge cycles. In another embodiment, the energy storage device may be employed in a variety of applications; and the plurality of cycles for recharge is dependent on factors such as charge and discharge current, depth of discharge, cell voltage limits, and the like.

Various embodiments of the energy storage system can store an amount of energy that is in a range of from about 0.1 kiloWatt hours (kWh) to about 1000 kWh. One embodiment of the energy storage system has an energy-by-weight ratio of greater than about 100 Watt-Hours per kilogram, and/or an energy-by-volume ratio of greater than about 200 Watt-Hours per liter. Another embodiment of the energy storage system has a specific power rating of greater than about 150 Watts per kilogram; and/or an energy-by-volume ratio of greater than about 300 Watt-Hours per liter.

Suitable energy storage systems may have an application specific power to energy ratio of less than about 10 per hour to about 1 per hour. In one embodiment, the specific power to energy ratio is in a range from about 1:1 to about 2:1, from about 2:1 to about 4:1, from about 4:1 to about 6:1, from about 6:1 to about 8:1, or from about 8:1 to about 10:1. In other embodiments, the power to energy ratio is in range from about 1:1 to about 1:2, from about 1:2 to about 1:4, from about 1:4 to about 1:6, from about 1:6 to about 1:8, or from about 1:8 to about 1:10.

In one embodiment of the energy storage system, a controller communicates with the plurality of the cells. The controller can distribute an electrical load to select cells in a cell module, in response to feedback signals indicating states for each of the cells in the cell module. The controller can perform a re-warm method, in which a series of heating elements are activated in a sequence to melt a frozen portion of the energy storage device in a pre-determined manner. In another embodiment, the controller may distribute an electrical load to select cathodic materials at pre-determined locations within individual cells.

In one embodiment, a heat management device maintains the temperature of the energy storage system. The heat management device can warm the energy storage system if it becomes too cold, and can cool the energy storage system if it becomes too hot, to prevent an accelerated cell degradation. The heat management system often includes a thaw profile that can maintain a minimal heat level in the anode and positive electrode chambers, to avoid freezing of cell reagents.

### EXAMPLES

The following examples illustrate methods and embodiments in accordance with the present disclosure, and as such should not be construed as imposing limitations upon the claims. Electrochemical cells having similar construction but with different positive electrode compositions were tested. Table 1 provides the electrode compositions.

TABLE 1

| | Comp. A | Comp. B |
|---|---|---|
| | (with no Manganese) | (with Manganese) |
| | (Percent by Weight | (Percent by Weight |
| Materials | of Granule Portion) | of Granule Portion) |
| Ni | 46.24% | 46.32% |
| NaCl | 38.11% | 38.18% |
| Fe | 10.10% | 8.69% |
| FeS | 1.49% | 1.49% |
| NaF | 2.21% | 2.22% |
| Al | 0.68% | 0.51% |
| Nal | 1.17% | 1.17% |
| Mn | 0% | 1.43% |
| NaAlCl₄ | 45.94% | 46.43% |

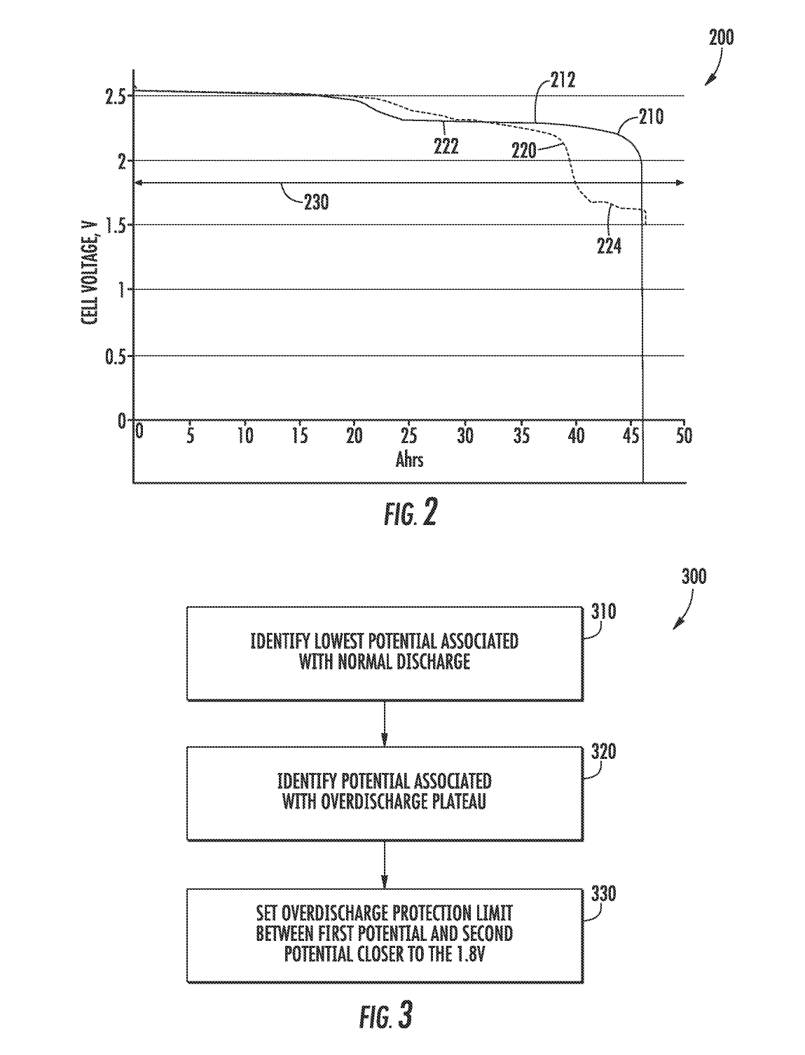

The cell testing results are depicted in FIG. 2. The graphical representation 200 plots Ahrs along the abscissa and cell voltage along the ordinate. Curve 210 represents a 4A discharge of a composition A, which does not include manganese. As shown, the composition A has a first discharge plateau 212 (resulting from a Fe/FeCl₂ couple) at a potential between 2 V and 2.5 V. As further demonstrated by curve 210, once the cell voltage drops below a certain voltage (e.g. as indicated by overdischarge protection limit 230), the overdischarge plateau 212 will no longer provide overdischarge protection for the cell, leading to a rapid cell failure.

Curve 220 represents a 4A discharge of composition B, which does include manganese in an amount sufficient to create an additional overdischarge plateau. As shown, the composition B has a first discharge plateau 212 (resulting from a Fe/FeCl₂ couple) and a second discharge plateau 214 (resulting from a Mn/MnCl₂ couple). The second discharge plateau 214 can provide additional overdischarge protection for the electrochemical cell. For instance, even when the voltage of the cell drops below the overdischarge protection limit 230, the second discharge plateau 214 can provide additional overdischarge protection for the cell prior to cell failure.

According to example aspects of the present disclosure, an overdischarge protection limit 230 for a control system controlling the charging and discharging of energy storage devices can be set between a potential associated with the first plateau 212 and a potential associated with the second plateau 214 to provide enhanced overdischarge for the energy storage devices.

FIG. 3 depicts an example method (300) of controlling an energy storage device according to example embodiments of the present disclosure. FIG. 3 depicts steps performed in a particular order for purposes of illustration and discussion. Those of ordinary skill in the art, using the disclosures provided herein, will understand that the various steps of any of the methods disclosed herein can be adapted, modified, expanded, rearranged, and/or omitted in various ways without deviating from the scope of the present disclosure.

At (310), the method includes identifying a first potential associated with a normal discharge (e.g., a lowest potential associated with discharge) that is attributable to, for instance, iron in the positive electrode composition of the energy storage device. For instance, a first potential normal discharge plateau 222 of FIG. 2 can be identified.

At (320) of FIG. 3, the method includes identifying a second potential associated with an overdischarge plateau attributable to the manganese in the positive electrode composition. For instance, a second potential associated with discharge plateau 224 of FIG. 2 can be identified. The second potential can be less than the first potential.

At (330) of FIG. 3, the method can include setting an overdischarge protection limit for the control system based at least in part on the first potential and the second potential. For instance, the overdischarge protection limit can be set at a value between the first potential and the second potential. FIG. 2 depicts an example overdischarge protection limit 230 set between the first potential associated with overdischarge plateau 222 and the second potential associated with overdischarge plateau 224. In some embodiments, the overdischarge protection limit 230 can be set to be closer in value to the second potential. In one example, the overdischarge protection limit 230 can set to be about 1.8V.

As demonstrated, the present inventors have discovered that the presence of manganese or manganese chloride at relatively low levels can lead to certain advantages, namely the presence of an overdischarge plateau at a lower potential relative to an overdischarge plateau associated with, for instance, iron present in the positive electrode composition. The inventors have also discovered that higher levels of manganese, e.g., above about 2% by weight of the electrode composition, can have a detrimental effect on energy discharge times.

The foregoing examples are illustrative of some features of the disclosure. Where necessary, ranges have been supplied, and those ranges are inclusive of all sub-ranges there between. It is to be expected that variations in these ranges will suggest themselves to a practitioner having ordinary skill in the art and, where not already dedicated to the public, the appended claims should cover those variations.

Reactants and components referred to by chemical name or formula in the specification or claims hereof, whether referred to in the singular or plural, may be identified as they exist prior to coming into contact with another substance referred to by chemical name or chemical type (e.g., another reactant or a solvent). Preliminary and/or transitional chemical changes, transformations, or reactions, if any, that take place in the resulting mixture, solution, or reaction medium may be identified as intermediate species, master batches, and the like, and may have a utility distinct from the utility of the reaction product or final material. Other subsequent changes, transformations, or reactions may result from bringing the specified reactants and/or components together under the conditions called for pursuant to this disclosure. In these other subsequent changes, transformations, or reactions, the reactants, ingredients, or the components to be brought together may identify or indicate the reaction product. All ranges disclosed herein are inclusive of the endpoints, and the endpoints are combinable with each other.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cathode composition for an electrochemical cell, the composition comprising:
at least one electroactive metal selected from the group consisting of nickel, titanium, vanadium, niobium, molybdenum, cobalt, chromium, silver, antimony, cadmium, tin, lead, and zinc;
at least one alkali metal halide;
an electrolyte salt comprising a reaction product of a second alkali metal halide and a metal halide, wherein the electrolyte salt has a melting point of less than about 300 degrees Celsius; and
manganese present in an amount sufficient to create an overdischarge plateau for the electrochemical cell.

2. The cathode composition of claim 1, wherein the manganese includes manganese chloride.

3. The cathode composition of claim 1, wherein the manganese is present in amount ranging from about 0.3% by weight of a granule portion the cathode composition to about 2% by weight of the granule portion the cathode composition.

4. The cathode composition of claim 3, wherein the manganese is present in an amount of about 1.4% by weight of the granule portion the cathode composition.

5. The cathode composition of claim 1, further comprising iron present in an amount sufficient to create an additional overdischarge plateau for the electrochemical cell, the additional overdischarge plateau being associated with a potential greater than a potential associated with the overdischarge plateau.

6. The cathode composition of claim 5, wherein the iron is present in an amount ranging from about 5% by weight of a granule portion of the cathode composition to about 10% by weight of the granule portion of the cathode composition.

7. The cathode composition of claim 1, wherein the at least one electroactive metal is nickel.

8. The cathode composition of claim 1, wherein the first and second alkali metal halides comprise, independently, sodium, potassium or lithium.

9. The cathode composition of claim 8, wherein the first and second alkali metal halides comprise, independently, chlorine, bromine, and fluorine.

10. The cathode composition of claim 1, further comprising aluminum.

11. An energy storage device, comprising:
a positive electrode composition disposed in a positive electrode compartment, the positive electrode composition comprising:
at least one electroactive metal selected from the group consisting of nickel, titanium, vanadium, niobium, molybdenum, cobalt, chromium, silver, antimony, cadmium, tin, lead, and zinc;
at least one alkali metal halide;
an electrolyte salt comprising a reaction product of a second alkali metal halide and a metal halide, wherein the electrolyte salt has a melting point of less than about 300 degrees Celsius; and
manganese present in an amount sufficient to create an overdischarge plateau for the energy storage device.

12. The energy storage device of claim 11, wherein the energy storage device further comprises an anode compartment.

13. The energy storage device of claim 11, wherein the energy storage device further comprises a separator separating the positive electrode compartment and the anode compartment.

14. The energy storage device of claim 11, wherein the manganese includes manganese chloride.

15. The energy storage device of claim 11, wherein the manganese is present in amount ranging from about 0.3% by weight of a granule portion of the positive electrode composition to about 2% by weight of the granule portion of the positive electrode composition.

16. The energy storage device of claim 11, wherein the manganese is present in an amount of about 1.4% by weight of the granule portion the positive electrode composition.

17. A method of controlling an energy storage device, the energy storage device having a positive composition, the positive composition comprising at least one electroactive metal selected from the group consisting of nickel, titanium, vanadium, niobium, molybdenum, cobalt, chromium, silver, antimony, cadmium, tin, lead, and zinc; at least one alkali metal halide; an electrolyte salt comprising a reaction product of a second alkali metal halide and a metal halide, wherein the electrolyte salt has a melting point of less than about 300 degrees Celsius; and
manganese present in amount ranging from about 0.3% by weight of a granule portion of the positive electrode composition to about 2% by weight of the granule portion of the positive electrode composition; and iron present in an amount ranging from about 5% by weight of the granule portion of the positive electrode composition to 10% by weight of the granule portion of the positive electrode composition; the method comprising:
identifying a first potential associated with a first overdischarge plateau attributable at least in part to the manganese;
identifying a second potential associated with a normal discharge attributable at least in part to the iron; and
setting an overdischarge protection limit for a control system for controlling the energy storage device based at least in part on the first potential and the second potential.

18. The method of claim 17, wherein the first potential is less than the second potential.

19. The method of claim 17, wherein the overdischarge protection limit is set at a value between the first potential and the second potential.

20. The method of claim 17, wherein the overdischarge protection limit is set at a value closer to the first potential relative to the second potential.
